(19) United States
(12) Patent Application Publication
(10) Pub. No.: US 2008/0122801 A1
(43) Pub. Date: May 29, 2008

(54) ELECTRONIC DEVICES HAVING A TOUCH SCREEN AND METHOD FOR STARTING THE ELECTRONIC DEVICES

(75) Inventors: CHUNG-YANG KO, Tu-Cheng (TW); CHIN-FENG CHEN, Tu-Cheng (TW); TAY-YANG LIN, Tu-Cheng (TW); YUAN-HUNG CHIEN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/843,662

(22) Filed: Aug. 23, 2007

(30) Foreign Application Priority Data
Nov. 24, 2006 (CN) 200610201140.0

(51) Int. Cl. G06F 3/041

(52) U.S. Cl. 345/174

(57) ABSTRACT

An exemplary electronic device (10) comprises a display (11), a chip controller (131), a power supply (14) and a main processor (12). The display has a touch screen (111). The power supply is electrically connected to and controlled by the chip controller. The main processor is electrically connected to the chip controller. The main processor is used to store a start operational input and calculate a touched signal that the touch screen is touched. The main processor further compares the touched signal with the start operational input to decide whether to send a start instruction to the chip controller to start the electronic device. The present invention further provides a method for starting the electronic device.

### CROSS-REFERENCE TO RELATED APPLICATIONS

This application is related to four co-pending U.S. Patent Applications (Attorney Docket No. US11801, US11802, US11803, US11805), all entitled “ELECTRONIC DEVICES HAVING A TOUCH SCREEN AND METHOD FOR STARTING THE ELECTRONIC DEVICES”, by Chung-Yang Ko et al. Such applications have the same assignee as the instant application and are concurrently filed herewith. The disclosure of the above-identified applications is incorporated herein by reference.

### BACKGROUND OF THE INVENTION

1. Field of the Invention

The present invention relates to electronic devices having a touch screen and methods for starting the electronic devices.

2. Discussion of the Related Art

Nowadays, electronic devices are popular and are used in a variety of situations. However, electronic devices also carry certain risks. For example, personal information stored in electronic devices such as mobile phones, personal digital assistants (PDAs) and personal computers may be stolen by others.

One typical electronic device includes an on/off key and a lock/unlock key. Anyone can turn on or unlock the electronic device by pressing the on/off key or the lock/unlock key when the electronic device is turned off or locked. Thus, information stored in the electronic device can be easily accessed and used for malicious purposes. In order to keep information secured, passwords are usually required when turning on or unlocking the electronic device. However, inputting passwords often involves typing several letters and/or numbers on a keyboard, making it very inconvenient to turn on or unlock the electronic device.

Therefore, a need exist for electronic devices that can conveniently be turned on or unlock, to keep information secured, and the methods thereof.

### SUMMARY

An exemplary electronic device includes a display having a touch screen, a chip controller, a power supply and a main processor. The power supply is electrically connected to and controlled by the chip controller. The main processor is electrically connected to the touch screen, and the chip controller. The main processor is used to store a start operational input including at least one of a predetermined touched area, a predetermined touched duration, and a predetermined number of touched times and calculate a touched signal including at least one of touched position, touched duration, and number of touched times that the touch screen is touched. The main processor is used to further compare the touched signal with the start operational input to decide whether to send a start instruction to the chip controller to start the electronic device. The touch screen includes a faradic sheet. The faradic sheet includes a plurality of first coils and is electrically connected to the main processor and an alternating current power supply. The alternating current power supply is connected to the main processor. The electronic device further includes a faradic stylus. The stylus includes a resonant circuit having a second coil and a capacitor.

Other advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present electronic device and a method for starting the electronic device, and associated electronic device. Moreover, in the drawings, like reference numerals designate corresponding parts throughout the several views, and all the views are schematic.

FIG. 1 is a schematic view of an electronic device in accordance with an exemplary embodiment of the present invention.

FIG. 2 is a schematic view showing the touch screen of the electronic device of FIG. 1.

FIG. 3 is a schematic view of a resonant circuit of a faradic stylus of the touch screen of FIG. 2.

FIG. 4 is a top plan view of the touch screen of FIG. 2 divided by imaginary lines.

FIG. 5 is a flow chart of starting the electronic device of FIG. 1.

### DETAILED DESCRIPTION OF THE EMBODIMENTS

The present invention provides an electronic device such as a mobile phone or a PDA, and a method for starting the electronic device.

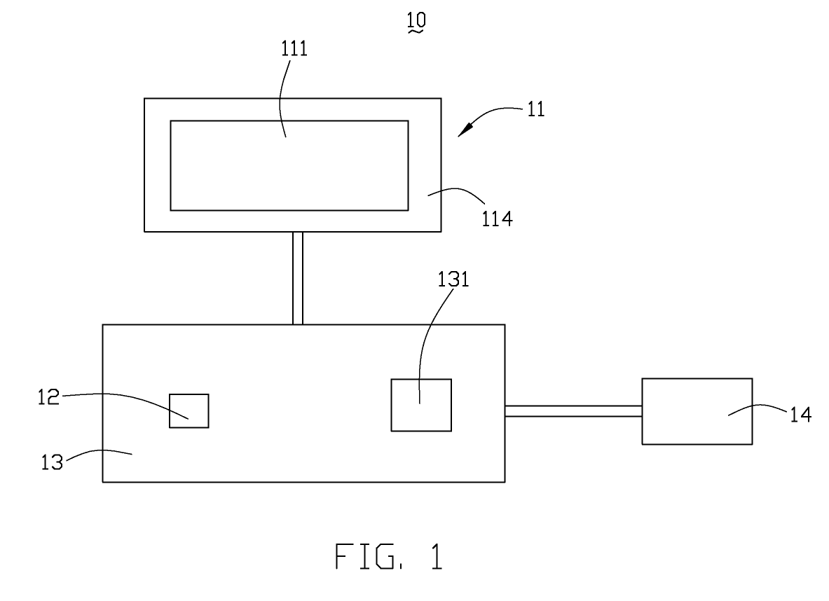

Referring to FIG. 1, an electronic device 10 includes a display 11, a main processor 12, a circuit board 13, and a power supply 14. The display 11 includes a frame 114 and a touch screen 111 confined within the frame 114. A chip controller 131 is mounted on the circuit board 13. The main processor 12 is mounted on the circuit board 13. The display 11 is electrically connected to the main processor 12 via the circuit board 13, and the power supply 14 is electrically connected to the chip controller 131 via the circuit board 13. The chip controller 131 is electrically connected to the main processor 12 via the circuit board 13. Alternatively, the main processor 12 can also be outside the circuit board 13 and directly connected to the display 11 and the power supply 14.

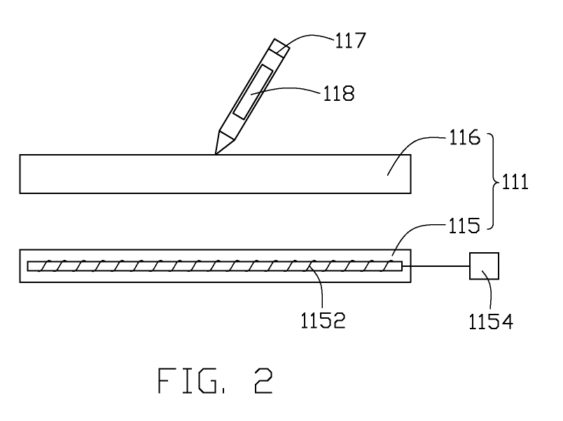

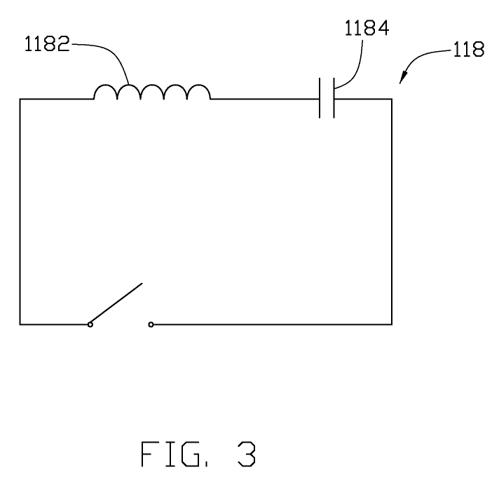

Also referring to FIG. 2, the touch screen 111 is an electromagnetic touch screen. The touch screen 111 includes a faradic sheet 115 and a protective layer 116 located on the faradic sheet 115 and configured to protect the touch screen 111. The faradic sheet 115 includes a plurality of first coils 1152 disposed in different positions. The faradic sheet 115 is electrically connected to the main processor 12 and an AC (alternating current) power supply 1154. The AC power supply 1154 is also connected to and controlled by the main processor 12. The electronic device 10 further includes a stylus 117. Also referring to FIG. 3, the stylus 117 includes a resonant circuit 118 having a second coil 1182 and a capacitor 1184.

How the touch screen 111 works is described hereinafter. The AC power supply 1154 provides an alternating current to the first coil 1152 of the faradic sheet 115. A first electromagnetic field is generated when the alternating current flows through the first coil 1152. A first induced current is generated in the second coil 1182 and the capacitor 1184 of the stylus 117 becomes charged when the stylus 117 enters this first electromagnetic field. The stylus 117 experiences the strongest first electromagnetic field when the stylus 117 touches the touch screen 111 because the stylus 117 is closest to the first coil 1152. The AC power supply 1154 stops providing alternating current to the first coils 1152. Consequently, the first electromagnetic field collapses. The resonant circuit 118 of the stylus 117 discharges, thereby a current flows in the resonant circuit 118. As such, a second electromagnetic field is generated in the stylus 117. This second electromagnetic field of the resonant circuit 118 influences the first coils 1152 of the faradic sheet 115 to generate second induced currents. The main processor 12 can calculate a coordinate of a touched point of the touch screen 111 according to signals of the second induced currents generated by the first coils 1152. A touched duration and a number of touched times (i.e., the touch screen 111 is touched for two times or three times etc.) can also be calculated by the main processor 12 according to the induced current. Thereby, the main processor 12 calculates a touched signal including the touched area, the touched duration, and the number of touched times.

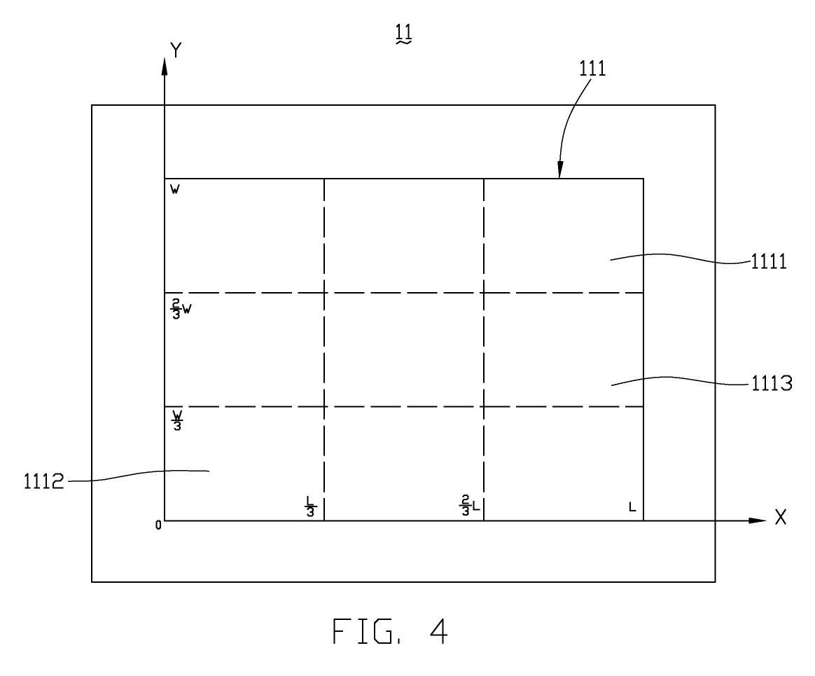

The touch screen 111 of the electronic device 10, controlled by the main processor 12, is divided into several areas including areas 1111, 1112, and 1113. Referring to FIG. 4, the touch screen 111 with a length of “L” in an X-direction and a width of “W” in a Y-direction is divided into nine areas, each of the nine areas having a length of “L/3” in the X-direction and a width of “W/3” in the Y-direction. Alternatively, the touch screen 111 can also be divided into any number of areas such as four or more than four areas. For each area, the area is regarded as touched when any point in the area is touched.

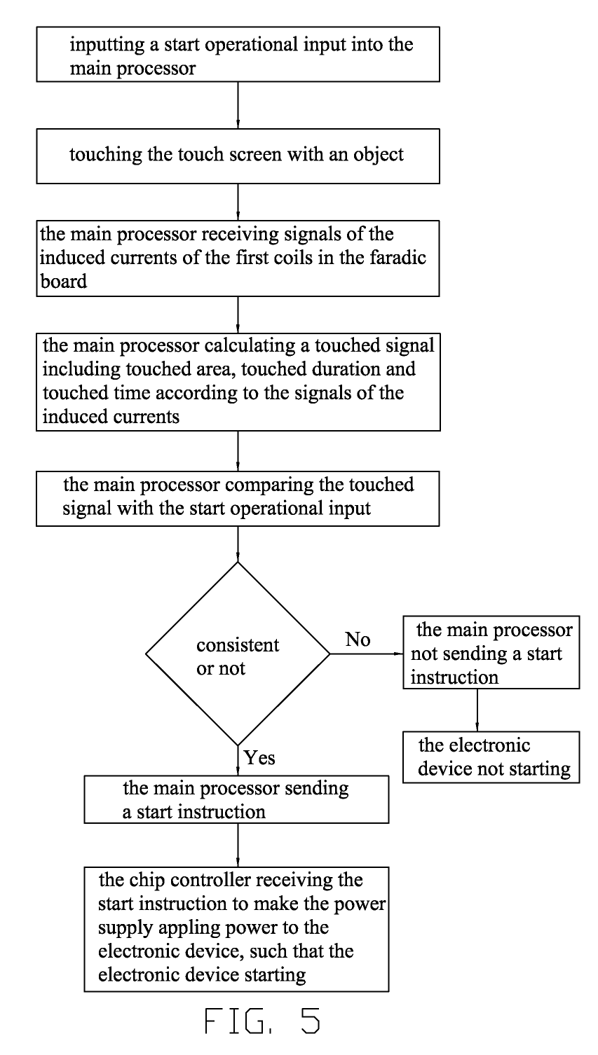

Also referring to FIG. 5, a method for starting the electronic device 10 is also provided as follow:
(1) A start operational input including a predetermined touched area, a predetermined touched duration, and a predetermined number of touched times is inputted into and stored in the main processor 12;
(2) An object such as the stylus 117 touches the touch screen 111. The object must have the resonant circuit 118 therein;
(3) As described above, the main processor 12 receives the signals of the induced currents of the first coils 1152 in the faradic sheet 115;
(4) The main processor 12 calculates the touched signal including the touched areas, the touched duration and the number of touched times according to the signals of the induced currents; and
(5) The main processor 12 compares the touched signal with the start operational input. If the touched signal is the same as the start operational input, the main processor 12 generates and sends the start instruction to the chip controller 131 of the circuit board 13 to make the power supply 14 applying power to the touch screen 111. Then the electronic device 10 starts (including turn on and unlock). If the touched signal is different from the start operational input, the electronic device 10 does not start.

Referring to FIG. 4, for example, the start operational input includes: simultaneously touching the areas 1111, 1112 for at least five seconds three times. That is, only when areas 1111, 1112 are simultaneously touched for at least five seconds three times, the main processor 12 sends a start instruction and the electronic device 10 starts. If areas 1111, 1113 are simultaneously touched for at least five seconds three times, the main processor 12 calculates the touched signal and compares the touched signal with the start operational input. The main processor 12 does not send any start instruction for starting the electronic device 10 because the touched area of the touched signal is not consistent with the predetermined touched area of the start operational input. If areas 1111, 1112 are simultaneously touched for three seconds three times, the main processor 12 does not send any start instruction for starting the electronic device 10 because the touched duration of the touched signal is not consistent with the predetermined touched duration of the start operational input. If areas 1111, 1112 are simultaneously touched for at least five seconds twice, the main processor 12 does not send any start instruction for starting the electronic device 10 because the number of touched times of the touched signal is not consistent with the predetermined number of touched times of the start operational input.

The electronic device can also be started or unlocked by using one or two of the three predetermined touch values. In other words, the start operational input signal may be activated using one or two of the touch values instead of all three. For example, the start operational input includes the predetermined touched area, only. With this condition, no matter how long and how many times the touch screen 111 is touched as long as the touched position is consistent with the touched area of the start operational input, the main processor 12 sends the start instruction for starting the electronic device 10. Thus, only one start operational input is needed to turn on or unlock the electronic device 10. With this condition, the main processor 12 always compares the touched signal with the start operational input to turn on or unlock the electronic device 10. In another example, the start operational input includes two touch values, a predetermined touched area and a predetermined touched duration. With this condition, no matter how many times the touch screen 111 is touched as long as the touched position and the touched duration are consistent with the touched area and the touched duration of the start operational input, the main processor 12 sends the start instruction for starting the electronic device 10. Thus, only two values, of the start operational input, are needed to turn on or unlock the electronic device 10.

Additionally, a start operational input may be used for turning on the electronic device and a different start operational input may be used for unlocking the electronic device. With this condition, the main processor 12 compares the touched signal with one of the start operational inputs regarded as the turning on signal to turn on the electronic device 10 and compares another touched signal with the other start operational input regarded as the unlocking signal to unlock the electronic device 10.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An electronic device comprising:
a display having an electromagnetic touch screen, the touch screen comprising a faradic sheet having a plurality of first coils, the faradic sheet being electrically connected to an alternating current power supply, and the electronic device further comprising a faradic stylus having a resonant circuit having a second coil and a capacitor;
a chip controller;
a power supply electrically connected to and controlled by the chip controller; and
a main processor electrically connected to the touch screen, the chip controller, and the faradic sheet, the alternating current power supply being connected to and controlled by the main processor, wherein the main processor being used to store a start operational input including at least one of a predetermined touched area, a predetermined touched duration, and a predetermined number of touched times and calculate a touched signal including at least one of touched position, touched duration, and number of touched times that the touch screen is touched, the main processor being used to further compare the touched signal with the start operational input to decide whether to send a start instruction to the chip controller to start the electronic device.

2. The electronic device as claimed in claim 1, wherein the touch screen further comprises a protective layer located on the faradic sheet and configured to protect the touch screen.

3. The electronic device as claimed in claim 1, wherein the alternating current power supply provides an alternating current to the first coils of the faradic sheet, a first electromagnetic field is generated when the alternating current flows through the first coil, a first induced current is generated in the second coil and the capacitor of the stylus becomes charged when the stylus enters the first electromagnetic field, then the alternating current power supply stops providing alternating current to the first coils, the resonant circuit of the stylus discharges thereby a current flows in the resonant circuit, as such a second electromagnetic field is generated in the stylus, then the second electromagnetic field influences the first coils of the faradic sheet to generate second induced currents, the main processor calculates the touched signal according to the second induced currents flowing in the faradic sheet.

4. The electronic device as claimed in claim 2, wherein the display further comprises a frame for confining the touch screen.

5. The electronic device as claimed in claim 1, wherein the touch screen comprises several areas defined by the main processor.

6. The electronic device as claimed in claim 1 further comprising a circuit board, the main processor and the chip controller are electrically connected to the circuit board respectively.

7. The electronic device as claimed in claim 1 further comprising a circuit board, the chip controller is electrically connected to the circuit board, and the main processor is positioned inside the display.

8. A method for starting an electronic device comprising:
providing an electronic device comprising a display, a chip controller, a power supply and a main processor, the power supply electrically connected to and controlled by the chip controller, the main processor electrically connected to the chip controller, the display having a touch screen, the touch screen comprising a faradic sheet having a plurality of first coils, the faradic sheet electrically connected to the main processor and an alternating current power supply, the alternating current power supply connected to the main processor, the electronic device further comprising a faradic stylus having a resonant circuit having a second coil and a capacitor;
inputting a start operational input including at least one of a predetermined touched area, a predetermined touched duration and a predetermined number of touched times into the main processor;
touching the touch screen;
the main processor getting information of the touch screen being touched;
the main processor calculating a touched signal including touched areas, touched duration and number of touched times according to the information, and the main processor comparing the touched signal with the start operational input;
the main processor sending a start instruction to the chip controller and the chip controller making the power supply applying power to start the electronic device if the touched signal being consistent with the start operational input.

9. The method as claimed in claim 8, wherein the alternating current power supply provides an alternating current to the first coils of the faradic sheet, a first electromagnetic field is generated when the alternating current flows through the first coil, a first induced current is generated in the second coil and the capacitor of the stylus becomes charged when the stylus enters the first electromagnetic field, then the alternating current power supply stops providing alternating current to the first coils, the resonant circuit of the stylus discharges thereby a current flows in the resonant circuit, as such a second electromagnetic field, then the second electromagnetic field of the resonant circuit influences the first coils of the faradic sheet to generate second induced currents, the main processor calculates the touched signal according to the second induced currents flowing in the faradic sheet.

10. The method as claimed in claim 8, wherein the display further comprises a frame for confining the touch screen.

11. The method as claimed in claim 8, wherein the touch screen comprises several areas defined by the main processor.

12. The method as claimed in claim 8 further comprising a circuit board, the main processor and the chip controller are electrically connected to the circuit board.
